(19) United States
(12) Patent Application Publication
(10) Pub. No.: US 2017/0177583 A1
(43) Pub. Date: Jun. 22, 2017

(54) SYSTEM AND METHOD FOR IDENTIFYING GIFTS HAVING SHARED INTERESTS VIA SOCIAL MEDIA NETWORKING, USER PROFILES AND BROWSING DATA

(71) Applicant: International Business Machines Corporation, Armonk, NY (US)

(72) Inventors: Carlos H. Cardonha, Sao Paulo (BR); Marco A. S. Netto, Sao Paulo (BR); Vagner F. de Santana, Sao Paulo (BR)

(21) Appl. No.: 14/979,240

(22) Filed: Dec. 22, 2015

(51) Int. Cl. G06F 17/30; H04L 12/58; H04L 29/08

(52) U.S. Cl. CPC G06F 17/3053; H04L 67/306; H04L 51/32; G06F 17/30905; H04L 67/02

(57) ABSTRACT

A method and system identifying gifts having shared interests of a gifter and gift receivers based on social network connections, user profiles data and browsing data. The method includes obtaining gifter identification as gift receivers. The system ranks gift receivers with upcoming life events selected from gifter social network connections. The system acquires profile data and browsing data of the gifter and gift receivers, and identifies their interests to render gift recommendations for gift receivers based on shared interests between the gifter and gift receivers. The system then presents a list of identified gifts to the gifter and allows interaction through a user interface. The shared interests in one embodiment are mutual interests of the gifter and gift receivers and in another embodiment the shared interests are different interests of the gifter and gift receivers.

### BACKGROUND OF THE INVENTION

This disclosure is directed to computer generated gift lists and more particularly, to computer generated gift lists targeted for the receiver of the gift.

Today, common advertisements shown by search engines, social media networks, and e-commerce websites are targeted to users accessing these services. However, in several cases, users are not looking for products for themselves, but for gifts for other people. The problem is therefore that the advertisement is not targeted to the right people at the right time. In this context, buying gifts is a difficult process depending on the case. In several other cases, users are not searching for gifts but are potential buyers who might decide to purchase gifts acknowledging others with upcoming events. However, it is difficult to know what the best gift is for the occasion.

### SUMMARY OF THE INVENTION

One embodiment of this disclosure is directed to a method for identifying gifts having shared interests of a gifter and gift receivers based on social network connections, user profiles data and browsing data. The method includes obtaining gifter identification from a user interface accessing a service provider website. The method also includes capturing gifter social network connections from one or more social networks and selecting one or more of the captured gifter connections with upcoming life events as one or more gift receivers. Then, the method next includes ranking the one or more gift receivers by social network proximity between the gifter and each of the one or more gift receivers.

The method further includes acquiring profile data and browsing data of the one or more gift receivers from the service provider and also acquiring the gifter's profile data and browsing data from the service provider. Then, the method includes identifying interests of the gifter and the one or more gift receivers based on the profile data and browsing data.

Thereafter, the method includes identifying gifts for each of the one or more gift receivers, each gift having shared interests of the gifter and one of the one or more gift receivers. Further, the method includes presenting a list of gifts for each of the one or more gift receivers to the gifter and allowing the gifter to interact with the gift list on the user interface.

In one embodiment, the shared interests are mutual interests of the gifter and gift receivers; in another embodiment, the shared interests are different interests of the gifter and gift receivers.

In one embodiment, ranking the gifter connections by social network proximity between the gifter and the gift receiver includes using social network media to obtain links between the gifter and gift receivers. Examples of such links include using family and friend relationship level, number of social network messages, number of likes in messages, number of shared posts, similarities between topics of the messages, co-occurrence in photos, number of common friends, number of events that both gifter and gift receiver attended, number of mentions, number of retweets, number of years working together, number of years studying together, etc.

In one embodiment, the method further includes ranking the gifts on the gift list by similarity between the shared interests of the gifter and the gift receiver. The gifts on the gift list are determined to have shared interests of the gifter and gift receivers by using product descriptions available to the service provider. In one embodiment, the gift list is presented in one or more advertisements for the products on the list with a hyperlink that allows the gifter to be transferred to the product website to make a purchase. In another embodiment, the method further including detecting gifter interests from the interaction, updating the browsing data of the gifter and updating the gift list based on the updated gifter browsing data.

One embodiment is directed to a non-transitory article of manufacture tangibly embodying computer readable instructions, which when implemented, cause a computer to perform the steps of a method for identifying gifts having shared interests of a gifter and gift receivers based on social network connections, user profiles data and browsing data, in which the method includes obtaining gifter identification from a user interface accessing a service provider website. The method also includes capturing gifter social network connections from one or more social networks and selecting one or more of the captured gifter connections with upcoming life events as one or more gift receivers. Then, the method next includes ranking the one or more gift receivers by social network proximity between the gifter and each of the one or more gift receivers.

The computer readable instructions cause the computer to further perform acquiring profile data and browsing data of the one or more gift receivers from the service provider; and acquiring the gifter's profile and browsing data from the service provider; and then identify interests of the gifter and gift receivers based on the profile data and browsing data.

The computer readable instructions causes the computer to further perform identifying gifts for each of the one or more gift receivers, presenting a list of identified gifts for each of the one or more gift receivers to gifter and allowing gifter to interact with the gift list on the user interface.

One embodiment is directed to a computer system for identifying gifts having shared interests of a gifter and gift receivers based on social network connections, user profiles data and browsing data. The computer system includes one or more computer processors including a shared interests gifts module and a life events module, one or more non-transitory computer-readable storage media and program instructions, stored on the one or more non-transitory computer-readable storage media, which when implemented by a user interface accessing a service provider website, cause the computer system to perform the steps of obtaining gifter identification from a user interface accessing a service provider website. The method also includes capturing gifter social network connections from one or more social networks and selecting one or more of the captured gifter connections with upcoming life events as one or more gift receivers. Then, the method next includes ranking the one or more gift receivers by social network proximity between the gifter and each of the one or more gift receivers.

The program instructions cause the computer to further perform acquiring profile data and browsing data of the one or more gift receivers from the service provider; acquiring the gifter's profile and browsing data from the service provider; and then identify interests of the gifter and gift receivers based on the profile data and browsing data.

The program instructions cause the computer to further perform identifying gifts for each of the one or more gift receivers, presenting a list of identified gifts for each of the one or more gift receivers to gifter and allowing gifter to interact with the gift list on the user interface.

### BRIEF DESCRIPTION OF THE DRAWINGS

These and other objects, features and advantages of the present invention will become apparent from the following detailed description, which is to be read in connection with the accompanying drawings, in which:

FIG. 1 is a block diagram of one embodiment of the system of the invention.

FIG. 2 is the flow chart of the steps of one embodiment of the method of the invention.

FIG. 3 is a block diagram of an exemplary computing system suitable for implementation of this invention.

### DETAILED DESCRIPTION

This invention is a system and method for identifying gifts having shared interests of a gifter and gift receivers based on social network connections, user profiles data and browsing data. The goal is to automatically select and present to a user products that share interests of the gifter and gift receivers, especially close to important dates such as birthdays, holidays, and weddings, among others. The method includes obtaining gifter identification of gift receivers. The system ranks gift receivers selected from gifter social network connections with upcoming life events. The system acquires profile data and browsing data of the gifter and gift receivers and identifies their interests to generate gift lists for the gift receivers based on shared interest between the gifter and gift receivers. The system then presents the list to the gifter and allows interaction through a user interface.

The system, in one embodiment, will automatically render a gift list for users without their intention shown to purchase a gift for another. Once a user accesses a website having the system, the system automatically captures gifter connections through social networks; selects gifter connections with upcoming life events; ranks connections by social network proximity between the gifter and gift receiver; obtains the gifter and gift receiver's profile as well as browsing data; identifies interests of the gifter and gift receiver based on the profiles data and browsing data; and identifies gifts for gift receivers, each gift having shared interests of the gifter and one of the one or more gift receivers.

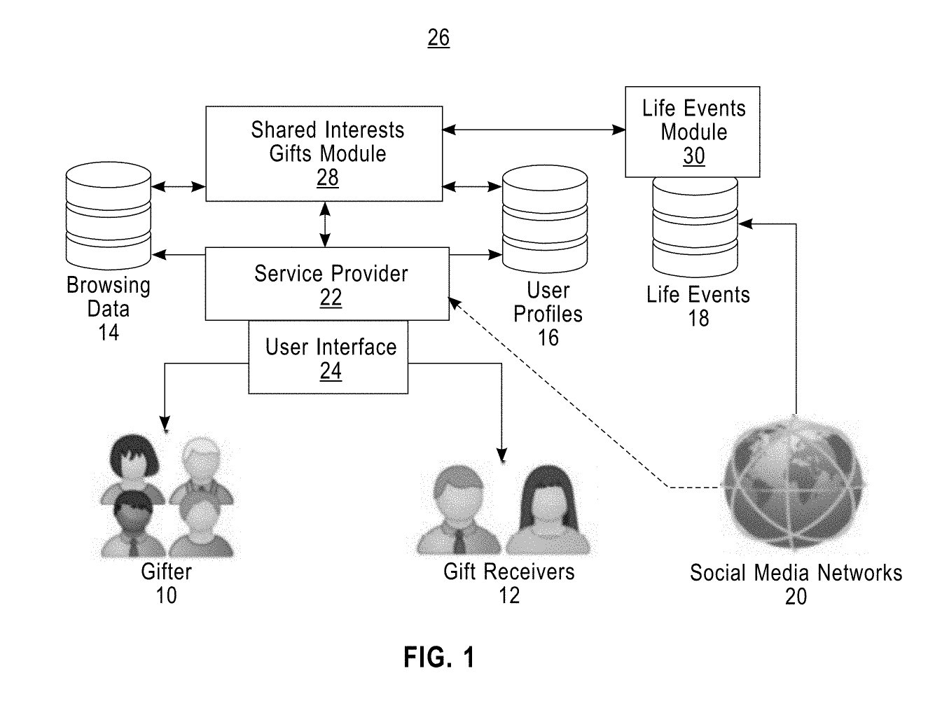

As shown in FIG. 1, the diagram depicts one embodiment of the system of the invention. Gifters 10 are people who are potential purchasers who may or may not have a specific intention to purchase a gift. These users receive gift advertisements rendered by the system. Gift receivers 12 are people who receive gifts from gifters 10. Gift receivers 12 have social network connections with gifters 10 and the connections are evaluated by the system.

Browsing database 14 includes any data related to web browsing coming from both gifters 10 and gift receivers 12. Search queries, clicks with advertisements, ‘likes’ in social media network are common browsing data examples. User profiles database 16 is summaries of gifters' preferences and gift receivers' preferences, such as ‘this user likes music’, ‘this user likes action movies’, etc. The profile database 16 and the browsing database 14 are accessed by the service provider 22. Life events database 18 contains information related to special events to users of social media networks 20, including birthdays, weddings, travels, and calendar events such as Christmas. Life events database 18 collects life events from social networks 20 allowing the system to offer gift lists for gifters 10 who do not have the intention to purchase gift for another when they access the website. Social media networks 20 includes networks where people interact with one another via message and photo exchanging, such as Facebook®, Twitter®, etc.

Service provider 22 is any website that offers advertisements to users that access the website. Many such websites are those that offer services such as selling products. Other websites that provide advertisements include social media sites, search engines, among others. Service provider 22 supplies browsing data from database 14 and user profiles from database 16 for the system to evaluate.

User interface 24 is user interaction with the service provider 22. User interface 24 can be realized on any smart phone, tablet, computers, etc., that can allow access to the website of the service provider 22.

In one embodiment, gift selection and advertisement system 26 of the invention includes a shared interests gifts module 28 and a life events module 30. Life events module 30 analyzes the connections of the gifter 10 for persons that have upcoming life events 18, identifies them as possible gift receivers 12 and filters the connections for use by the shared interests gifts module 28. The shared interests module 28 analyzes information including browsing data from database 14, user profiles from database 16 and life events from life events module 30, identifies gifts having shared interests of the gifter and gift receiver and provides a gift list for gifters 10.

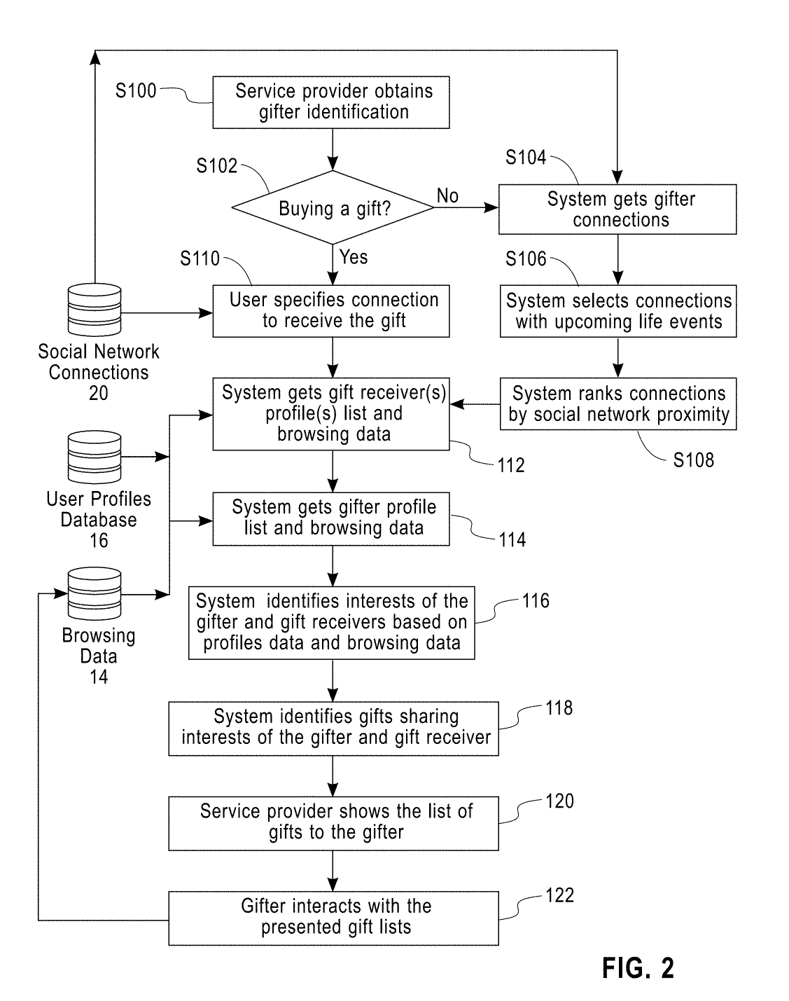

As is shown in FIG. 2, one embodiment of the method of the invention begins with step S100 of service provider obtaining gifter identification when the gifter accesses the service provider's website. At step S102 the system questions whether the gifter has an intention of purchasing a gift.

At step S104 if the intention from step S102 is negative, system will automatically capture gifter connections through social networks. The method further includes step S106 in which the system selects gifter connections with upcoming life events and at step S108 ranks connections by social network proximity between the gifter and gift receivers using social media links. Examples of the links to determine proximity include family and friend relationship level and number of social network messages, number of likes in messages, number of shared posts, similarities between topics of the messages, co-occurrence in photos, number of common friends, number of events that both gifter and gift receiver attended, number of mentions, number of retweets, number of years working together, number of years studying together, etc.

At step S110, if the intention from step S102 is positive, the gifter will specify the identification of the potential gift receiver and the connection within their social network connections. Further at step S112 the system obtains the gift receiver's profiles data as well as browsing data.

At step S114, the system acquires the gifter profiles data and browsing data from gifter's profiles database 16 and gifter's browsing database 14, further at step S116 identifies interests of the gifter and gift receivers for either the connections with the highest proximity ranking from step S108 or the identified connection from step S110. During S116, the system identifies interests of the gifter and gift receiver by analyzing both parties' profiles data from database 16 and browse data from database 14. The method then in step S118 identifies gifts having shared interests of the gifter and gift receivers. In one embodiment, the shared interests are mutual interests of the gifter and gift receivers; in another embodiment, the shared interests are different interests of the gifter and gift receivers. The gift list containing identified gifts is a personalized gift list based on shared interests via social media networking, user profiles and browsing data of the gifter and gift receiver. The system selects products that combine interests of the gifters and gift receivers, especially close to important dates such as birthdays, holidays, weddings, among others. The products are determined to be based on the descriptions of the products available to the service provider. One approach consists of identifying keywords to preferences of the gifter, keywords to preferences of the gift receiver, and keywords to products. Products containing a large number of keywords which appear on the list of keywords of the gifter and/or of the gift receiver are potentially good candidates for gifts. Further, at step S120 service provider presents the list of gifts to gifter. In one embodiment, the gift list is presented in one or more advertisements for the products on the list. At step S122 the gifter interacts with the gift list through the user interface. In one embodiment, the advertisement allows the gifter to be transferred to the product website to make a purchase. In step S122, the system detects the gifter interests by way of the interaction with the gift list and records the interests back into the system for refinement of the gift list and/or for future interactions. In one embodiment, the process repeats from step S114 acquiring gifter profile list and browsing data; identifying interests of the gifter and gift receivers; identifying gifts having shared interests of the gifter and gift receivers until the gifter is satisfied with the gift choice.

In one exemplary use of the system, a user goes to a social media network website to use the site as usual. The website uses the system's advertisement services and finds out that this user has a very good friend and that his friend's birthday is in one week. The user likes rock music and his friend likes retro-video games. The advertisement system suggests to the user products of rock music and video games, such as a t-shirt with a video game characters playing guitar. The system generates a gift list that considers gifts that have shared interests of the gifter and gift receiver. In the above example, the video game is gift receiver's interest, while the guitar embodying rock music is the gifter's interest. The gifter is presented with the gift advertisement suggesting t-shirt with a video game character playing guitar, which is a single product targeting the shared interests of both the gifter and gift receiver.

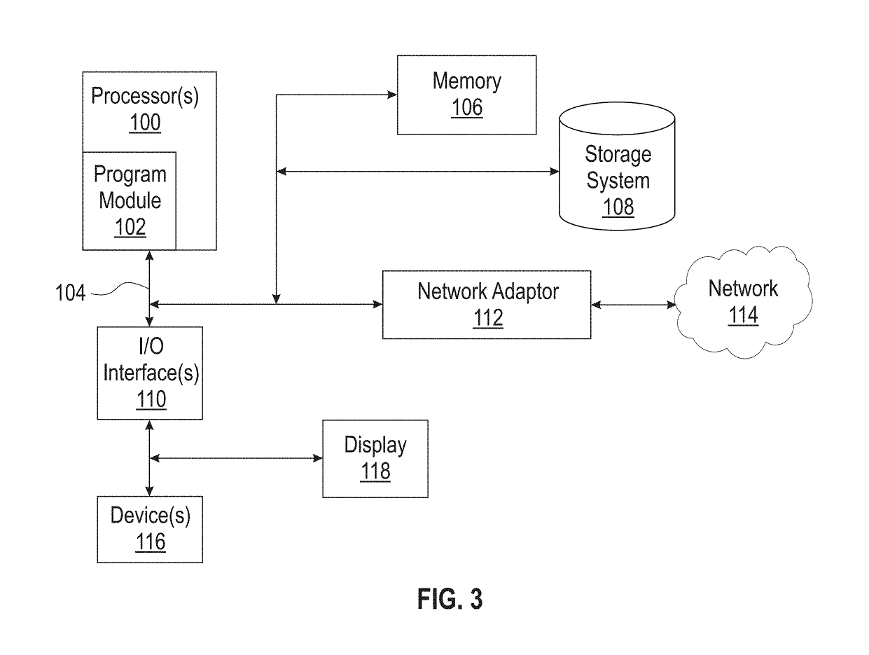

FIG. 3 illustrates a schematic of an example computer or processing system that may implement the method for creating personalized gift list based on shared interest via social media networking, user profiles and browsing data. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 3 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 100, a system memory 106, and a bus 104 that couples various system components including system memory 106 to processor 100. The processor 100 may include a program module 102 that performs the methods described herein. The module 102 may be programmed into the integrated circuits of the processor 100, or loaded from memory 106, storage device 108, or network 114 or combinations thereof.

Bus 104 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 106 can include computer system readable media in the form of volatile memory, such as random access memory (RAM) and/or cache memory or others. Computer system may further include other removable/non-removable, volatile/non-volatile computer system storage media. By way of example only, storage system 108 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 104 by one or more data media interfaces.

Computer system may also communicate with one or more external devices 116 such as a keyboard, a pointing device, a display 118, etc.; one or more devices that enable a user to interact with computer system; and/or any devices (e.g., network card, modem, etc.) that enable computer system to communicate with one or more other computing devices. Such communication can occur via Input/Output (I/O) interfaces 110.

Still yet, computer system can communicate with one or more networks 114 such as a local area network (LAN), a general wide area network (WAN), and/or a public network (e.g., the Internet) via network adapter 112. As depicted, network adapter 112 communicates with the other components of computer system via bus 104. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a non-transitory computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In addition, while preferred embodiments of the present invention have been described using specific terms, such description is for illustrative purposes only, and it is to be understood that changes and variations may be made without departing from the spirit or scope of the following claims.

1. A method for identifying gifts having shared interests of a gifter and gift receivers based on social network connections, user profiles data and browsing data, comprising:
obtaining gifter identification from a user interface accessing a service provider website;
capturing gifter social network connections from one or more social networks;
selecting one or more of the captured gifter connections with upcoming life events as one or more gift receivers;
ranking the one or more gift receivers by social network proximity between the gifter and each of the one or more gift receivers;
acquiring profile data and browsing data of the one or more gift receivers from the service provider;
acquiring the gifter's profile data and browsing data from the service provider;
identifying a first interest of the gifter and at least one second interest of the one or more gift receivers based on the profile data and browsing data, the first and second interests being different;
selecting gifts for each of the one or more gift receivers that combines the first and second interests, each gift combining an element related to the first interest and an element related to the second interest;
presenting a list of the selected gifts for each of the one or more gift receivers to the gifter; and
allowing the gifter to interact with the gift list on the user interface.

2. The method of claim 1, wherein the selected gifts have elements related to mutual interests of the gifter and one of the one or more gift receivers.

3. (canceled)

4. The method of claim 1, wherein ranking gifter connections by social network proximity between the gifter and gift receivers includes using social network media to obtain links between the gifter and gift receivers.

5. The method of claim 1, further comprising ranking the gifts on the gift list by similarity between the first and second interests.

6. The method of claim 1, wherein the selecting gifts includes using product descriptions available to the service provider.

7. The method of claim 1, wherein the gift list is presented in one or more advertisements for the products on the list with a hyperlink that allows the gifter to be transferred to the product website to make a purchase.

8. The method of claim 1 further including detecting gifter interests from the interaction, updating the browsing data of the gifter and updating the gift list based on the updated gifter browsing data.

9. The method of claim 1, wherein the links are one or more of family and friend relationship level, number of social network messages, number of likes in messages, number of shared posts, similarities between topics of the messages, co-occurrence in photos, number of common friends, number of events that both gifter and gift receiver attended, number of mentions, number of retweets, number of years working together and number of years studying together.

10. A non-transitory article of manufacture tangibly embodying computer readable instructions, which when implemented, cause a computer to perform the steps of a method for identifying gifts having shared interests of a gifter and gift receivers based on social network connections, user profiles data and browsing data, comprising:
obtaining gifter identification from a user interface accessing a service provider website;
capturing gifter social network connections from one or more social networks;
selecting one or more of the captured gifter connections with upcoming life events as one or more gift receivers;
ranking the one or more gift receivers by social network proximity between the gifter and each of the one or more gift receivers;
acquiring profile data and browsing data of the one or more gift receivers from the service provider;
acquiring the gifter's profile data and browsing data from the service provider;
identifying a first interest of the gifter and at least one second interest of the one or more gift receivers based on the profile data and browsing data, the first and second interests being different;
selecting gifts for each of the one or more gift receivers that combines the first and second interests, each gift combining an element related to the first interest and an element related to the second interest;
presenting a list of the selected gifts for each of the one or more gift receivers to the gifter; and
allowing the gifter to interact with the gift list on the user interface.

11. The non-transitory article of manufacture of claim 10, wherein the selected gifts have elements related to mutual interests of the.

12. The non-transitory article of manufacture of claim 10, wherein ranking gifter connections by social network proximity between the gifter and gift receivers includes using social network media to obtain links between the gifter and gift receivers and the links are one or more of family and friend relationship level, number of social network messages, number of likes in messages, number of shared posts, similarities between topics of the messages, co-occurrence in photos, number of common friends, number of events that both gifter and gift receiver attended, number of mentions, number of retweets, number of years working together and number of years studying together.

13. The non-transitory article of manufacture of claim 10, further comprising ranking the gifts on the gift list by similarity between the first and second interests.

14. The non-transitory article of manufacture of claim 10, wherein the selecting gifts includes using product descriptions available to the service provider and the gift list is presented in one or more advertisements for the products on the list with a hyperlink that allows the gifter to be transferred to the product website to make a purchase.

15. The non-transitory article of manufacture of claim 10, further including detecting gifter interests from the interaction, updating the browsing data of the gifter and updating the gift list based on the updated gifter browsing data.

16. A computer system comprising:
at least one data processor connected to at least one memory that stores software instructions, where execution of the software instructions by the at least one data processor causes the computer system to identify gifts having shared interests of a gifter and gift receivers based on social network connections, user profiles data and browsing data, by:
obtaining gifter identification from a user interface accessing a service provider website;
capturing gifter social network connections from one or more social networks;
selecting one or more of the captured gifter connections with upcoming life events as one or more gift receivers;
ranking the one or more gift receivers by social network proximity between the gifter and each of the one or more gift receivers;
acquiring profile data and browsing data of the one or more gift receivers from the service provider;
acquiring the gifter's profile data and browsing data from the service provider;
identifying a first interest of the gifter and at least one second interest of the one or more gift receivers based on the profile data and browsing data, the first and second interests being different;
selecting gifts for each of the one or more gift receivers that combines the first and second interests, each gift combining an element related to the first interest and an element related to the second interest;
presenting a list of the selected gifts for each of the one or more gift receivers to the gifter; and
allowing the gifter to interact with the gift list on the user interface.

17. The computer system of claim 16, wherein the selected gifts have elements related to mutual interests of the gifter.

18. The computer system of claim 16, wherein ranking gifter connections by social network proximity between the gifter and gift receivers includes using social network media to obtain links between the gifter and gift receivers and the links are one or more of family and friend relationship level, number of social network messages, number of likes in messages, number of shared posts, similarities between topics of the messages, co-occurrence in photos, number of common friends, number of events that both gifter and gift receiver attended, number of mentions, number of retweets, number of years working together and number of years studying together.

19. The computer system of claim 16, wherein selecting gifts includes using product descriptions available to the service provider and the gift list is presented in one or more advertisements for the products on the list with a hyperlink that allows the gifter to be transferred to the product website to make a purchase and the method further comprising ranking the gifts on the gift list by similarity between the shared interests of the gifter and the gift receivers.

20. The computer system of claim 16, further including the software instructions causing detecting gifter interests from the interaction, updating the browsing data of the gifter and updating the gift list based on the updated gifter browsing data.
